(19) United States
(12) Patent Application Publication
(10) Pub. No.: US 2025/0141010 A1
(43) Pub. Date: May 1, 2025

(54) Battery Module, and Battery Pack and Vehicle Including the Same

(71) Applicant: LG Energy Solution, Ltd., Seoul (KR)

(72) Inventors: Won-Sik Chung, Daejeon (KR); Young-Woong Kim, Daejeon (KR); Ji-Seon Mun, Daejeon (KR); Jae-Yong Uhm, Daejeon (KR); In-Seok Cha, Daejeon (KR); So-Young Pyun, Daejeon (KR); Jae-Cheol Hwang, Daejeon (KR)

(73) Assignee: LG Energy Solution, Ltd., Seoul (KR)

(21) Appl. No.: 18/926,500

(22) Filed: Oct. 25, 2024

(30) Foreign Application Priority Data
Oct. 25, 2023 (KR) 10-2023-0143787

(51) Int. Cl. H01M 50/242; H01M 50/249; H01M 50/293; H01M 50/505

(52) U.S. Cl. CPC H01M 50/242; H01M 50/249; H01M 50/293; H01M 50/505; H01M 2220/20

(57) ABSTRACT

Disclosed is a battery module, which includes a cell stack including a plurality of battery cells; a compression member disposed on at least one side of the cell stack and interposed in a gap between the battery cells, the compression member being configured to be shape-deformable by an external pressure; and a pressurizing member configured to pressurize the compression member on the at least one side of the cell stack.

### TECHNICAL FIELD

This application is based on and claims priority from Korean Patent Application No. 10-2023-0143787, filed on Oct. 25, 2023, with the Korean Intellectual Property Office, the disclosure of which is incorporated herein in its entirety by reference.

The present disclosure relates to a battery module, and a battery pack and a vehicle including the same.

### BACKGROUND ART

Secondary batteries, which are easy to apply depending on the product group and have electrical features such as high energy density and the like, are generally used in electric vehicles (EVs) or hybrid electric vehicles (HEVs) that are driven by an electrical drive source, as well as in portable devices. These secondary batteries are attracting attention as a new energy source for improving eco-friendliness and energy efficiency because of the primary advantage of dramatically reducing the use of fossil fuels and another advantage of not generating by-products resulting from energy use.

Current secondary batteries widely used include lithium-ion batteries, lithium-polymer batteries, nickel-cadmium batteries, nickel-hydrogen batteries, nickel-zinc batteries, and the like. If a higher output voltage is required, a battery module or battery pack may be configured by connecting a plurality of battery cells in series. In addition, a battery module or battery pack may be configured by connecting multiple battery cells in parallel in order to increase the charge/discharge capacity. Accordingly, the number of battery cells included in the battery module or battery pack may be set in various ways depending on the required output voltage or charge/discharge capacity.

Meanwhile, when configuring a battery pack by connecting a plurality of battery cells in series/parallel, it is common to first configure a battery module including at least one battery cell, and then configure a battery pack or battery rack by using the at least one battery module and adding other components. Alternatively, recently, a battery pack in the form of cell-to-pack, which do not modularize a plurality of battery cells but directly store a plurality of battery cells in a pack housing or the like is also being manufactured.

Meanwhile, since a pouch-type battery cell is manufactured by stacking electrodes and a separator, when charge and discharge cycles are repeated, a sliding phenomenon, where the electrodes and separators stacked on each other are pushed against each other, may occur at the edge of the battery cell. Accordingly, there is a problem that the thickness of the edge of the battery cell is reduced, and thus the thickness between the battery cells within the battery cell stack becomes uneven. This uneven thickness phenomenon may induce local degradation of the battery cell during the charge and discharge cycle of the battery cell.

In order to prevent swelling of battery cells from occurring during the charge and discharge cycle of the pouch-type battery cell, in the conventional battery module, a compression member such as a double-sided tape or a PU pad is applied between battery cells to pressurize the battery cells.

However, although the compression member may prevent swelling by pressurizing the battery cell, it is difficult to minimize the thickness deviation between the battery cells since different pressures are applied to local locations.

Therefore, there is a need to develop a structure that may extend the expected life of battery cells by uniformly pressurizing the battery cells and thus minimizing the thickness deviation between the battery cells.

### DISCLOSURE

### Technical Problem

The present disclosure is designed to solve the problems of the related art, and therefore the present disclosure is directed to providing a battery module, which may extend the life of a battery cell by minimizing the thickness deviation between battery cells, and a battery pack and a vehicle including the battery module.

However, the technical problems that the present disclosure seeks to solve are not limited to the above-mentioned problems, and other problems not mentioned above will be clearly understood by those skilled in the art from the description of the invention described below.

### Technical Solution

In one aspect of the present disclosure, there is provided a battery module comprising: a cell stack including a plurality of battery cells; a compression member disposed on at least one side of the cell stack and interposed in a gap between the battery cells, the compression member being configured to be shape-deformable by an external pressure; and a pressurizing member configured to pressurize the compression member on the at least one side of the cell stack.

The compression member may be interposed at least partially between sealing portions of neighboring battery cells.

The compression member may be interposed at least partially between storage portions of neighboring battery cells.

The pressurizing member may be provided in plurality and respectively provided between the sealing portions of the neighboring battery cells.

The pressurizing member may be configured to be partially in surface contact with the compression member.

The pressurizing member may be configured to extend in a height direction of the battery cell.

The pressurizing member may be provided on a side where electrode leads of the battery cell are located.

The battery module may further comprise a bus bar frame coupled to at least one side of the cell stack and configured to pressurize the pressurizing member toward the cell stack.

The pressurizing member may be mounted to the bus bar frame.

The bus bar frame may have a protrusion configured by at least partially protruding to contact the pressurizing member.

The bus bar frame may include a main frame configured to cover one side of the cell stack, and a lower frame bent from a lower portion of the main frame toward the cell stack to cover a lower portion of the compression member.

The lower frame may include a placing portion configured so that the cell stack is placed thereon, and a coupling portion configured so that the pressurizing member is coupled thereto.

The cell stack may further include a first blocking member disposed at an outermost side of the cell stack and configured to protrude outward rather than the pressurizing member.

The cell stack may further include a second blocking member disposed between the battery cells, and a length of the first blocking member may be longer than a length of the second blocking member.

Also, the present disclosure provides a battery pack including the battery module according to the present disclosure.

In addition, the present disclosure provides a vehicle including the battery module according to the present disclosure.

### Advantageous Effects

According to one aspect of the present disclosure, since the compression member uniformly compresses the battery cells, it is possible to minimize the thickness deviation between the battery cells, thereby extending the expected life of the battery cells. In particular, according to this aspect of the present disclosure, the performance of the battery cell may be maximized.

In addition, according to one aspect of the present disclosure, the process for coupling battery cells may be simplified. Accordingly, according to this aspect of the present disclosure, the cost and time for manufacturing a battery module may be reduced, thereby improving productivity.

In addition, the present disclosure may have various other effects, and these will be described in the respective embodiments, or description of effects that may be easily inferred by those skilled in the art will be omitted.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a perspective view showing a battery module according to an embodiment of the present disclosure.

FIG. 2 is an exploded perspective view showing the battery module according to an embodiment of the present disclosure.

FIG. 3 is a top view showing the battery module according to an embodiment of the present disclosure before a pressurizing member is coupled to a cell stack.

FIG. 4 is a top view showing the battery module according to an embodiment of the present disclosure in which the pressurizing member is coupled to the cell stack.

FIG. 5 is a top view showing a battery module according to another embodiment of the present disclosure in which the pressurizing member coupled to the cell stack.

FIG. 6 is an exploded perspective view showing some components of the battery module according to an embodiment of the present disclosure.

FIG. 7 is a top view showing the battery module according to an embodiment of the present disclosure before a bus bar frame is coupled to the cell stack.

FIG. 8 is a top view showing a portion of the battery module according to an embodiment of the present disclosure in which the bus bar frame is coupled to a cell stack. For example, FIG. 8 may be a cross-sectional view taken along line I-I′ of FIG. 1.

FIG. 9 is a side view showing a portion of the battery module according to an embodiment of the present disclosure to which the bus bar frame is applied. For example, FIG. 9 may be a cross-sectional view taken along line II-II′ of FIG. 1.

FIG. 10 is a side view showing a portion of a battery module according to another embodiment of the present disclosure to which the bus bar frame is applied. For example, FIG. 10 may be a cross-sectional view taken along line II-II′ of FIG. 1.

FIG. 11 is a perspective view showing a bus bar frame included in a battery module according to another embodiment of the present disclosure.

FIG. 12 is a cross-sectional view showing the battery module according to an embodiment of the present disclosure. For example, FIG. 12 may be a cross-sectional view taken along line I-I′ of FIG. 1.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclinvenosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

Also, the present disclosure includes many different embodiments. Substantially identical or similar components for these embodiments will be described in duplication, and different features will be described in detail.

Meanwhile, although terms indicating directions such as upward, downward, left, right, forward, and backward directions are used in this specification, it is obvious to those skilled in the art that these terms are only for convenience of explanation and may vary depending on the position of the target object or the position of the observer.

For example, in the embodiment of the present disclosure, the X-axis direction shown in the drawing may indicate the forward/backward direction, the Y-axis direction may indicate the left/right direction perpendicular to the X-axis direction on the flat plane (X-Y plane), and the Z-axis direction may indicate the upward/downward direction (vertical direction) perpendicular to both the X-axis direction and the Y-axis direction.

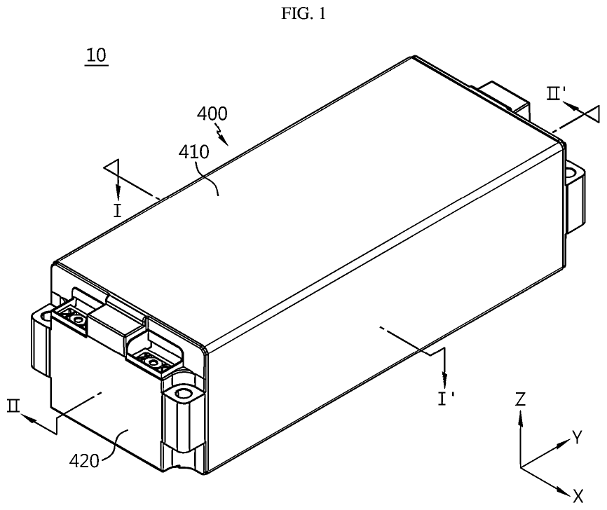

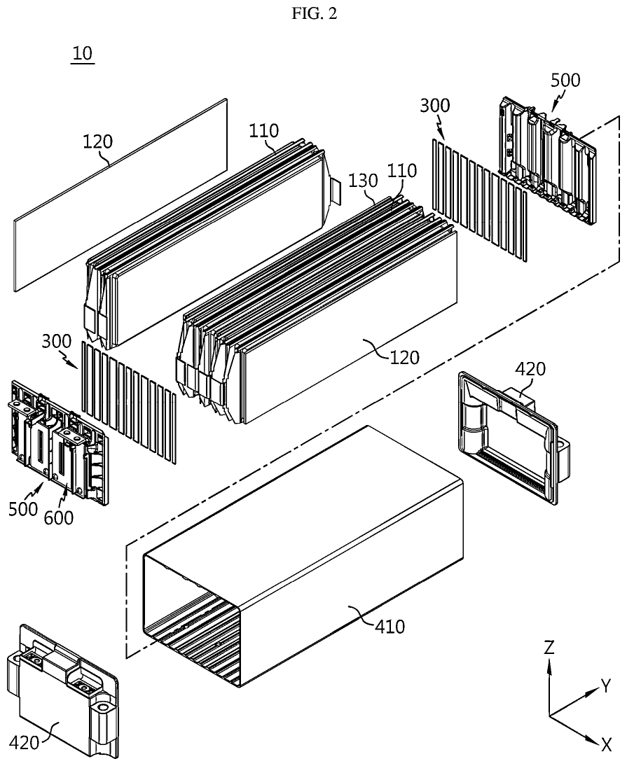

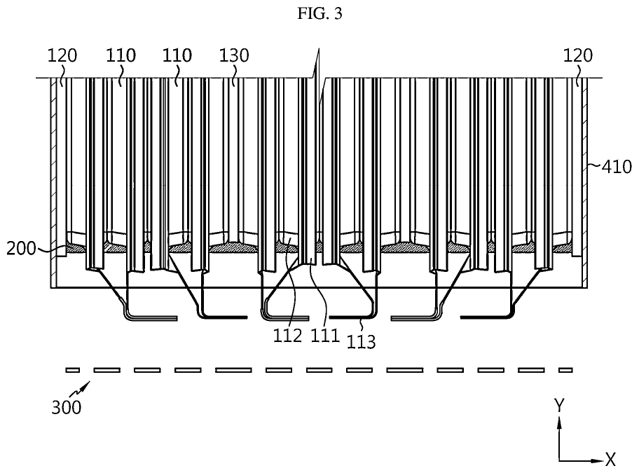

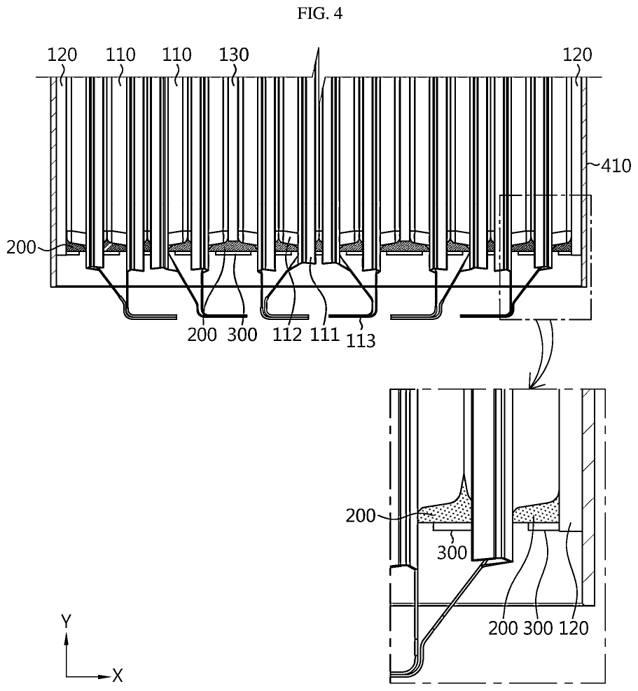

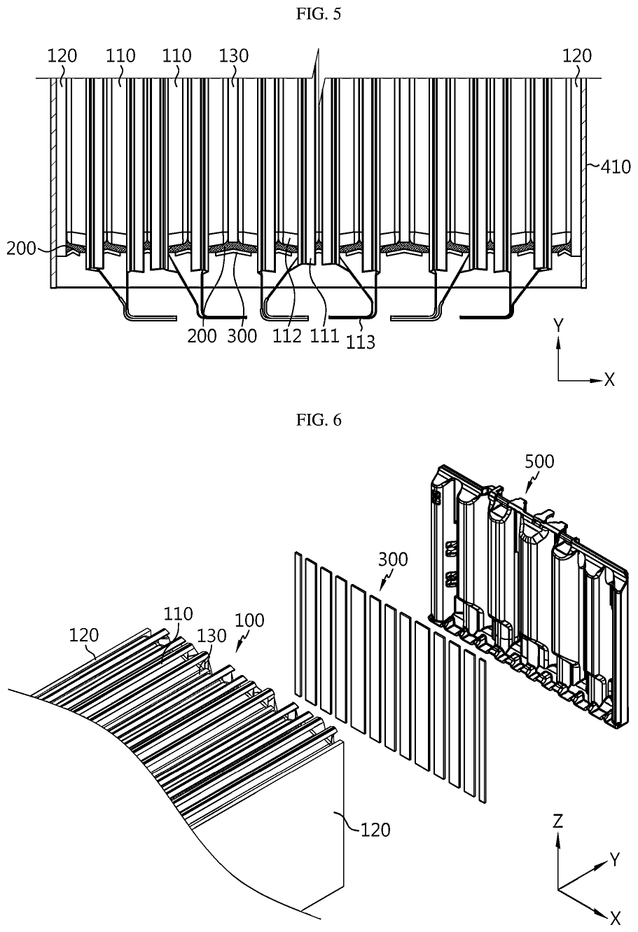

FIG. 1 is a perspective view showing a battery module according to an embodiment of the present disclosure, and FIG. 2 is an exploded perspective view showing the battery module according to an embodiment of the present disclosure. Also, FIG. 3 is a top view showing the battery module according to an embodiment of the present disclosure before a pressurizing member is coupled to a cell stack. In addition, FIG. 4 is a top view showing the battery module according to an embodiment of the present disclosure in which the pressurizing member is coupled to the cell stack, and FIG. 5 is a top view showing a battery module according to another embodiment of the present disclosure in which the pressurizing member coupled to the cell stack.

Referring to FIGS. 1 to 4, a battery module 10 according to an embodiment of the present disclosure includes a cell stack 100, a compression member 200, and a pressurizing member 300.

Referring to FIG. 2 mainly, the cell stack 100 may include a plurality of battery cells 110. The battery cell 110 may include an electrode assembly (including a positive electrode plate, a negative electrode plate, and a separator), an electrolyte, and a battery case. The plurality of battery cells 110 may be electrically connected to each other. For example, the plurality of battery cells 110 may be electrically connected to each other in series and/or in parallel via a bus bar or the like.

Meanwhile, the present disclosure is not limited by the specific type or shape of the battery cell 110, and various battery cells 110 known at the time of filing of this application may be employed to configure the battery module 10 of the present disclosure. In this embodiment, a pouch-type secondary battery having high energy density and easy stacking as shown in the drawings is used, but a rectangular secondary battery may also be applied as the battery cell 110 of the present disclosure.

Referring to FIG. 3, the battery cell 110 may include a storage portion 112 and a sealing portion 111. The storage portion 112 may be configured to accommodate an electrode assembly, and the sealing portion 111 may be configured such that an outer perimeter of the storage portion 112 is thermally fused for sealing.

The cell stack 100 may be prepared by stacking a plurality of battery cells 110 in one direction. For example, as shown in FIG. 2 or the like, the plurality of battery cells 110 may be disposed side by side in the left/right direction (X-axis direction) while standing in the vertical direction (Z-axis direction). In this case, a sealing portion 111 of each battery cell 110 may be directed in the forward/backward direction (Y-axis direction) and the upward/downward direction (Z-axis direction), and a storage portion 112 may be directed in the left/right direction (X-axis direction).

Referring to FIGS. 3 and 4, the compression member 200 may be disposed on at least one side of the cell stack 100. For example, the compression member 200 may be provided on both sides in the front and rear direction (Y-axis direction in the drawings) of the battery cell 110. Accordingly, the compression member 200 may be interposed at a longitudinal end of the battery cell 110.

At this time, the compression member 200 may be interposed in a gap between the battery cells 110. Specifically, the compression member 200 may be interposed at least partially in the gap between the sealing portions 111 and/or the storage portions 112 of neighboring battery cells 110.

The compression member 200 may be configured to be partially deformed in shape by an external pressure. Specifically, the compression member 200 may be deformed in shape to fit the shape of the gap between the battery cells 110 by an external pressure, for example by the pressurizing member 300. In particular, the compression member 200 may be configured to be partially deformed in thickness at a portion of the battery cells 110 where a thickness loss occurs.

The compression member 200 may be provided to contain an elastic material. For example, the compression member 200 may contain a material such as silicone or polyurethane, or may be made only of such a material. If the compression member 200 is made of an elastic material, the compression member 200 may be uniformly compressed by an external pressure, thereby further improving the sealing effect between the battery cells 110.

According to an embodiment of the present disclosure, the compression member 200 may be filled in the gap between the battery cells 110. The compression member 200 may be applied to both sides in the front and rear direction of the cell stack 100. The compression member 200 may be provided as a liquid and configured to be hardened over time after being applied to both sides in the front and rear direction of the cell stack 100.

As a result, the process of separately manufacturing the compression member 200 to correspond to the shape of the gap between the battery cells 110 is omitted, so that cost and time may be reduced when manufacturing the battery module. In addition, the compression member 200 may be applied to one side of the cell stack 100 with a uniform thickness according to the size or shape of the gap between the battery cells 110.

Meanwhile, the pressurizing member 300 may be provided on at least one side of the cell stack 100. The pressurizing member 300 may be configured to pressurize the compression member 200. That is, the pressurizing member 300 may be provided on the side where the compression member 200 is located and configured to pressurize the compression member 200. The pressurizing member 300 may be made of a metal or plastic material.

According to this embodiment of the present disclosure, since the pressurizing member 300 pressurizes the compression member 200, the compression member 200 may penetrate between the battery cells 110 and compensate for the thickness deviation of the battery cells 110. Therefore, according to this embodiment, local degradation of the battery cells 110 may be prevented during the charge and discharge cycle, thereby extending the expected life of the battery cells 110 and maximizing the performance of the battery cells 110.

Also, according to this embodiment of the present disclosure, since the compression member 200 and the pressurizing member 300 fix the battery cells 110 at both sides, the compression member 200 and the pressurizing member 300 may contribute to the structural rigidity of the battery cells 110.

In addition, the compression member 200 may perform a function of blocking heat, such as a flame generated from an ignited battery cell 110, from moving in the stacking direction of the battery cells 110 or the longitudinal direction of the battery cells 110 when an internal ignition of the battery module 10 occurs. Accordingly, thermal propagation to neighboring battery cells 110 may be minimized.

In addition, according to this embodiment, an adhesive material such as a tape for coupling neighboring battery cells 110 to each other be omitted. Accordingly, the process for coupling battery cells 110 to each other may be simplified, so that the cost and time for manufacturing a battery module may be reduced, thereby improving productivity.

Meanwhile, referring to FIGS. 1 and 2, the battery module 10 according to an embodiment of the present disclosure may further include a module case 400. The module case 400 may be configured to have an inner space formed therein and accommodate the cell stack 100, the compression member 200, and the pressurizing member 300 in the inner space. The module case 400 of this embodiment may include a case body 410, and end plates 420 disposed on the front and rear sides of the case body 410.

Here, the case body 410 has an upper plate, a lower plate, a left plate, and a right plate to form a storage space, and the cell stack 100 may be accommodated in this storage space. The case body 410 may be made of a metal material having rigidity and heat resistance to physically or chemically protect the accommodated cell stack 100.

In addition, the end plate 420 may be configured to be coupled with the case body 410 and cover an open portion of the case body 410. More specifically, the case body 410 may be configured to have open front and rear sides, and the end plate 420 may be configured to be coupled with the open front and rear sides of the case body 410.

Meanwhile, although not shown in the drawings, the case body 410 may have a venting hole, and directional venting in one direction may be possible. For example, a plurality of venting holes may be formed in the upper surface of the case body, and directional venting toward the top of the battery module 10 may be possible through the venting holes.

The compression member 200 may be at least partially interposed between the sealing portions 111 of the neighboring battery cells 110. For example, as in the embodiment illustrated in FIGS. 3 and 4, the compression member 200 may be provided between the sealing portions 111 positioned in the front and rear directions of the battery cells 110. That is, the compression member 200 may be provided to be surrounded by the sealing portions 111 and the storage portions 112 of the neighboring battery cells 110. Accordingly, the pressurizing member 300 may press the compression member 200 interposed between the sealing portions 111 protruding in the front and rear direction rather than the storage portion 112 toward the cell stack 100.

If the compression member 200 interposed between the sealing portions 111 is pressurized by the pressurizing member 300 before being cured, the compression member 200 may also be interposed between the storage portions 112. That is, the compression member 200 may be interposed at least partially between the storage portions 112 of the neighboring battery cells 110. At this time, the compression member 200 may be deformed in shape to be introduced between the storage portions 112 of the battery cells 110. The compression member 200 interposed between the storage portions 112 may be configured to pressurize the storage portions 112 of the neighboring battery cells 110.

According to this embodiment of the present disclosure, since the compression member 200 is provided between the storage portions 112 of the battery cells 110, the storage portions 112 of the battery cells 110 may be uniformly pressurized, thereby effectively alleviating the thickness deviation between the battery cells 110. In particular, since the compression member 200 is provided in each gap existing at the end of the storage portions 112 of the battery cells 110, the thickness sagging occurring at the end of the battery cells 110 may be compensated for.

Meanwhile, referring to FIG. 4, the pressurizing member 300 may be provided in plurality. The plurality of pressurizing members 300 may be provided to be spaced apart from each other by a predetermined interval along the stacking direction of the battery cells 110 in a straight line. The plurality of pressurizing members 300 may be respectively provided between the sealing portions 111 of neighboring battery cells 110. In addition, the plurality of pressurizing members 300 may be provided to face the storage portions 112 of the battery cells 110 in the front and rear direction. According to this embodiment of the present disclosure, the pressurizing members 300 may be provided in each space between neighboring battery cells 100 to pressurize the compression member 200 toward the cell stack 100.

In addition, the pressurizing member 300 may be configured to be in surface contact with the compression member 200. In other words, the pressurizing member 300 may be configured to be in surface contact with the compression member 200 interposed between the sealing portions 111 to pressurize the compression member 200. Specifically, the compression member 200 may be configured to have a flat outer surface, and the pressurizing member 300 may have a flat inner surface corresponding to the compression member 200. For example, as in the embodiment illustrated in FIG. 4, the pressurizing member 300 may be configured to face the outer surface of the compression member 200 in parallel.

The pressurizing member 300 may be configured to correspond to the shapes of the front and rear surfaces of the facing storage portion 112. For example, as in the embodiment illustrated in FIG. 5, each of the plurality of pressurizing members 300 may include a bent portion B. The bent portion B may be provided to be bent so as to be positioned between neighboring battery cells 110.

Alternatively, unlike this embodiment, the pressurizing member 300 may further include a protrusion configured to face parallel to the outer surface of the compression member 200, while a portion of the inner surface thereof protrudes to correspond to the shape of the battery cell 110.

According to this embodiment of the present disclosure, when the pressurizing member 300 pressurizes the compression member 200, the compression member 200 is pressed to correspond to the shape of the battery cell 110, so that the compression member 200 may be more easily introduced between the battery cells 110. Accordingly, according to this embodiment of the present disclosure, the compression member 200 may be provided to match the thickness or shape of the storage portion 112 of the battery cell 110 with a reduced thickness at the end. Accordingly, the compression member 200 may be pressed more closely against the end of the storage portion 112 between the battery cells 110.

Also, the pressurizing member 300 may be configured to extend in the height direction (Z-axis direction) of the battery cell 110. According to this embodiment of the present disclosure, the thickness sagging of the battery cell 110 may also be compensated in the height direction of the battery cell 110.

Meanwhile, referring to FIG. 4, each of the plurality of battery cells 110 may include an electrode lead 113. The electrode lead 113 may be connected to the electrode assembly and configured to extend outward from the battery case.

The electrode lead 113 may be provided as a pair, and the pair of electrode leads 113 may be drawn out from both ends of the battery cell 110, namely in the longitudinal direction (±Y direction). At this time, the pair of electrode leads 113 may be a positive electrode lead and a negative electrode lead. If necessary, the battery cell 110 may have a form in which two electrode leads 113 are located only at one end in the Y-axis direction, for example at the end in the +Y-axis direction.

At this time, the compression member 200 may be provided at the side where the electrode leads 113 of the battery cell 110 are located. Similarly, the pressurizing member 300 may also be provided at the side where the electrode leads 113 of the battery cell 110 are located. According to this embodiment of the present disclosure, the phenomenon in which the electrode plate and the separator inside the electrode assembly are pushed at the side where the electrode leads 113 are located may be effectively prevented. As a result, the thickness loss of the battery cell 110 at the side where the electrode leads 113 are located may be compensated for, thereby effectively preventing thickness unevenness of the battery cells 110.

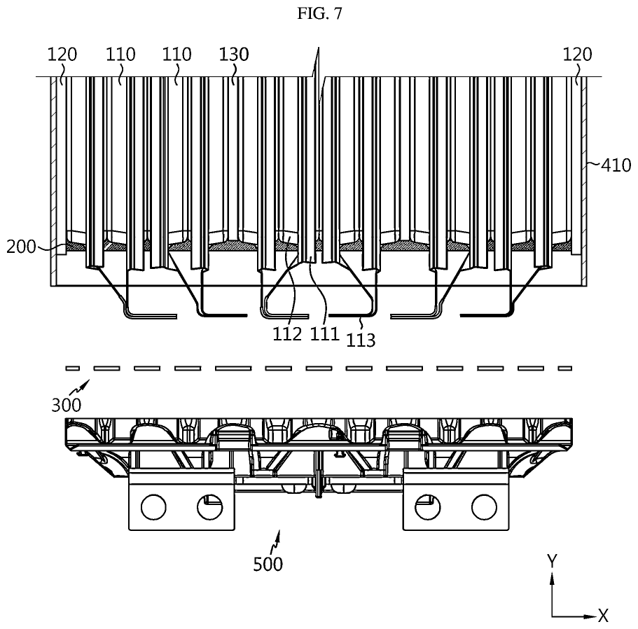

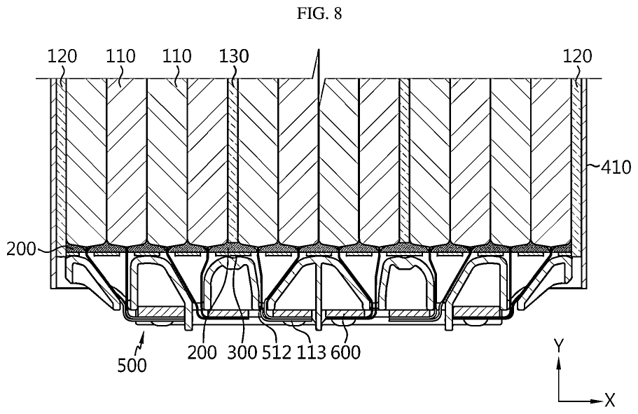

FIG. 6 is an exploded perspective view showing some components of the battery module according to an embodiment of the present disclosure. Also, FIG. 7 is a top view showing the battery module according to an embodiment of the present disclosure before a bus bar frame is coupled to the cell stack. In addition, FIG. 8 is a top view showing a portion of the battery module according to an embodiment of the present disclosure in which the bus bar frame is coupled to a cell stack. For example, FIG. 8 may be a cross-sectional view taken along line I-I′ of FIG. 1.

Referring to FIGS. 2, 6 to 8, the battery module 10 according to an embodiment of the present disclosure may further include a bus bar frame 500 and a bus bar 600.

The bus bar frame 500 may be coupled to at least one side of the cell stack 100. The bus bar frame 500 may be provided in a plate shape so as to cover both ends of the cell stack 100, and the front side (−Y direction) or the rear side (+Y direction) of the cell stack 100. The bus bar frame 500 may be made of an electrically insulating material such as plastic and may be injection-molded.

Referring to FIG. 8, the bus bar frame 500 may include a lead slot 512. The lead slot 512 may be located at a side where the electrode leads 113 of the plurality of battery cells 110 are provided. The lead slot 512 may be provided so that at least a portion of the electrode leads 113 of the plurality of battery cells 110 pass through. At this time, the plurality of electrode leads 113 passing through the lead slot 512 may be provided so as to be folded and laminated with each other. By this laminated structure, the plurality of battery cells 110 whose electrode leads 113 are in contact with each other may be electrically connected to each other.

The lead slot 512 may be provided in plurality so that the plurality of lead slots 512 are spaced apart from each other along the stacking direction (X direction) of the battery cells 110. In particular, the lead slots 512 may be provided in a staggered manner so as not to overlap with the pressurizing member 300.

The bus bar 600 may be provided on the outer surface of the bus bar frame 500. The bus bar 600 may be provided between the bus bar frame 500 and the laminated electrode lead 113. The bus bar 600 may be electrically connected to the electrode lead 113. Also, through the electrical connection, the bus bar 600 may be configured to transmit state information about the battery cell 110 to an external component. For example, the bus bar 600 may be configured to transmit voltage information of the battery cell 110 to an external control device such as a BMS (Battery Management System).

The bus bar 600 may be made of an electrically conductive material for transmitting electrical signals. For example, the bus bar 600 may be made of a material such as copper or aluminum.

Meanwhile, the bus bar frame 500 may be configured to pressurize the pressurizing member 300 toward the cell stack 100. In other words, when the bus bar frame 500 is coupled to at least one side of the cell stack 100, the bus bar frame 500 may be configured to compress the pressurizing member 300 toward the cell stack 100. Accordingly, the pressurizing member 300 may be configured to be pressed toward the cell stack 100 by the bus bar frame 500. In addition, the bus bar frame 500 may be configured to fix a pressurizing state of the pressurizing member 300 with respect to the compression member 200.

According to this embodiment, the bus bar frame 500 may maintain the pressurizing member 300 and the compression member 200 in close contact. Accordingly, the compression member 200 may reliably fill the gap between the battery cells 110, so that the thickness loss of the battery cells 110 included in the cell stack 100 may be effectively compensated for.

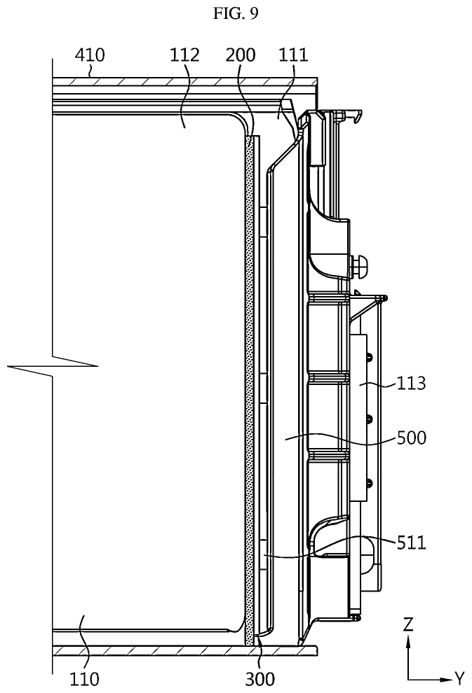

FIG. 9 is a side view showing a portion of the battery module according to an embodiment of the present disclosure to which the bus bar frame is applied. For example, FIG. 9 may be a cross-sectional view taken along line II-II′ of FIG. 1.

The pressurizing member 300 may be mounted on the bus bar frame 500. The pressurizing member 300 may be manufactured separately and coupled to the bus bar frame 500. For example, the pressurizing member 300 may be coupled to the bus bar frame 500 by welding, bolting, etc. Alternatively, the pressurizing member 300 may be provided integrally with the bus bar frame 500. For example, the pressurizing member 300 may be made by plastic injection molding together with the bus bar frame 500.

According to this embodiment of the present disclosure, since the pressurizing member 300 is mounted on the bus bar frame 500, the pressurizing member 300 may pressurize the compression member 200 simultaneously with assembling the bus bar frame 500 to the cell stack 100. Accordingly, the process for manufacturing the battery module is simplified, so that productivity may be improved.

According to an embodiment of the present disclosure, as in the embodiment illustrated in FIG. 9, the bus bar frame 500 may include a protrusion 511 configured by at least partially protruding. The protrusion 511 may be configured to contact the pressurizing member 300. That is, the protrusion 511 may be provided in a separated space between the bus bar frame 500 and the pressurizing member 300. Accordingly, when the bus bar frame 500 is coupled to at least one side of the cell stack 100, the protrusion 511 may be configured to pressurize the pressurizing member 300 toward the compression member 200. According to this embodiment of the present disclosure, the protrusion 511 may provide a pressing force for the pressurizing member 300 to pressurize the compression member 200.

The protrusion 511 may be provided in plurality, and the plurality of protrusions 511 may be provided to be spaced apart from each other along the height direction. Accordingly, the pressurizing member 300 may uniformly pressurize the compression member 200 along the height direction.

The pressurizing member 300 may be provided to be bonded or coupled to the protrusion 511. As a result, the pressurizing member 300 may be mounted to the bus bar frame 500. According to this embodiment of the present disclosure, since the pressurizing member 300 is mounted to the bus bar frame 500, the pressurizing member 300 may pressurize the compression member 200 simultaneously with assembling the bus bar frame 500 to the cell stack 100.

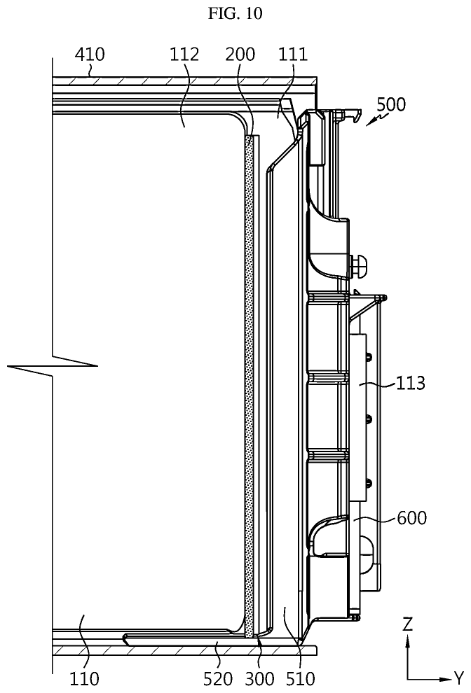

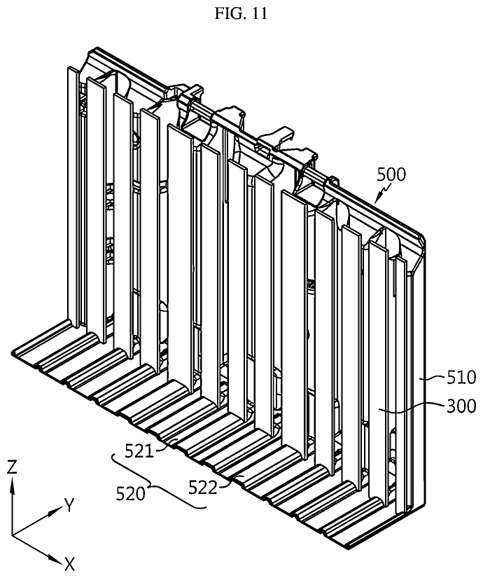

FIG. 10 is a side view showing a portion of a battery module according to another embodiment of the present disclosure to which the bus bar frame is applied. For example, FIG. 10 may be a cross-sectional view taken along line II-II′ of FIG. 1. Also, FIG. 11 is a perspective view showing a bus bar frame included in a battery module according to another embodiment of the present disclosure.

According to another embodiment of the present disclosure, as illustrated in FIGS. 10 and 11, the bus bar frame 500 may include a main frame 510 and a lower frame 520.

The main frame 510 may be configured to cover one side of the cell stack 100. The main frame 510 may be configured to cover at least one side in the front and rear direction of the cell stack 100. The main frame 510 may have a lead slot 512 through which the electrode lead 113 of the battery cell 110 may pass to the outside of the main frame 510. In addition, the bus bar 600 may be provided on the outer side of the main frame 510.

The lower frame 520 may be configured to be bent toward the cell stack 100 from the lower portion of the main frame 510. The lower frame 520 may be configured to cover at least a portion of the cell stack 100 from the lower portion. In addition, referring to FIG. 10, the lower frame 520 may be configured to cover the lower portion of the compression member 200. In particular, the lower frame 520 may be configured to contact or support the lower portion of the compression member 200. Accordingly, when the lower frame 520 is provided, the compression member 200 interposed between the battery cells 110 may be prevented from leaking downward.

In addition, the lower frame 520 may be configured to allow the pressurizing member 300 to be placed thereon. Specifically, referring to FIG. 11, the lower frame 520 may include a placing portion 521 configured to allow the cell stack 100 to be placed thereon, and a coupling portion 522 configured to allow the pressurizing member 300 to be coupled thereto. For example, the pressurizing member 300 may be coupled to the coupling portion 522 by welding.

According to this embodiment, since the lower end of the pressurizing member 300 is coupled and fixed to the lower frame 520, the pressurizing member 300 may pressurize the compression member 200 simultaneously with assembling the bus bar frame 500 to the cell stack 100. Accordingly, the process for manufacturing the battery module 10 is simplified, so that productivity may be improved.

At this time, according to another embodiment of the present disclosure, an elastic body may be further provided between the main frame 510 and the pressurizing member 300. For example, the elastic body may be provided as a leaf spring. According to this embodiment of the present disclosure, when the bus bar frame 500 is coupled to the cell stack 100 so that the pressurizing member 300 pressurizes the compression member 200, the elastic body acts as a buffer to prevent the cell stack 100 from being excessively pressurized and damaged.

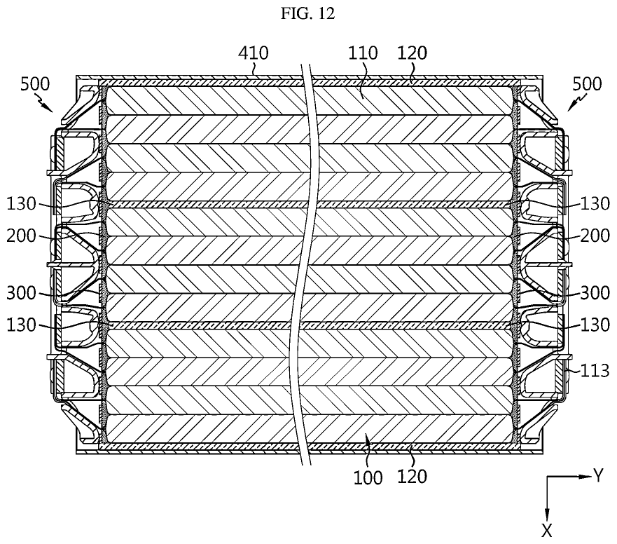

FIG. 12 is a cross-sectional view showing the battery module according to an embodiment of the present disclosure. For example, FIG. 12 may be a cross-sectional view taken along line I-I′ of FIG. 1.

Referring to FIG. 12, the cell stack 100 included in the battery module 10 of the present disclosure may include a blocking member 120, 130. The blocking member 120, 130 may be included in plurality. In this case, the plurality of blocking members 120 and 130 may be arranged to be spaced apart from each other by a predetermined distance in one direction, namely along the stacking direction (X-axis direction) of the battery cells 110. In addition, the plurality of blocking members 120 and 130 may be provided at regular intervals respectively for at least one battery cell 110 (e.g., for each battery cell 110 or for the plurality of battery cells 110). The blocking members 120 and 130 may be in direct contact with both sides of at least some battery cells 110 among the plurality of battery cells 110. In particular, the blocking members 120 and 130 may be in direct contact with the storage portion of the battery cell 110. In this embodiment, the blocking members 120 and 130 may be provided in plurality so as to be arranged for every two or more battery cells 110.

The blocking members 120 and 130 may be provided in the form of a compressible pad and made of materials with excellent heat resistance and/or fire resistance, such as silicone, aerogel, polyurethane, etc. Since the blocking members 120 and 130 are compressible pads, the blocking members 120 and 130 may suppress inflation of the battery cell 110 when the battery cell 110 experiences swelling.

In addition, when an internal ignition of the battery module 10 occurs, the blocking members 120 and 130 having the heat-resistant and/or fire-resistant function may perform a thermal barrier function to block heat, such as a flame, generated from the ignited battery cell 110 from progressing in the stacking direction of the battery cells 110. Accordingly, heat propagation to neighboring battery cells 110 may be minimized. The blocking members 120 and 130 may block not only heat but also high-temperature gases, flames, discharged substances, etc. generated from the battery cell 110. Accordingly, the blocking members 120 and 130 may partition or separate the battery cells 110, thereby preventing flames, etc. from spreading between the battery cells 110.

Specifically, the blocking members 120 and 130 may include a first blocking member 120 disposed at the outermost side of the cell stack 100 and a second blocking member 130 disposed between the battery cells 110. At this time, in the case of the battery cell 110 disposed at the outermost side of the cell stack 100, as illustrated in FIG. 4, the compression member 200 may be provided between the first blocking member 120 and a battery cell 110 adjacent thereto.

In addition, in the case of the battery cell 110 arranged in the central portion of the cell stack 100 and provided to face the second blocking member 130, the compression member 200 may be provided between neighboring battery cells 110 and between the battery cell 110 and the second blocking member 130. In this case, the pressurizing member 300 may be provided to face the second blocking member 130 between the neighboring battery cells 110.

The first blocking member 120 may be configured to protrude outward rather than the pressurizing member 300. In addition, the length of the first blocking member 120 may be longer than the length of the second blocking member 130. That is, the first blocking member 120 may be configured to protrude further to both sides in the longitudinal direction of the cell stack 100 than the second blocking member 130.

Accordingly, when the compression member 200 is provided in the battery cell 110 located at the outermost end of the cell stack 100, the compression member 200 may not be exposed to the outside. In addition, according to this embodiment of the present disclosure, the compression member 200 may be uniformly provided at both ends in the stacking direction of the cell stack 100, so that the thickness loss of the battery cell 110 located at the outermost end of the cell stack 100 may also be compensated for.

A battery pack according to an embodiment of the present disclosure may include one or more battery modules 10 according to an embodiment of the present disclosure as described above. The battery pack according to the present disclosure may further include components of the battery pack known at the time of filing of this application, such as a BMS (Battery Management System), a current sensor, a fuse, etc. for integrated control of charging and discharging of one or more battery modules.

In addition, in the battery pack according to the present disclosure, the module case 400 described above may serve as a pack case. In this case, components of the battery pack such as a BMS, a bus bar, and a relay may be included inside the module case 400. In this case, this is also called cell-to-pack since the battery cells 110 are directly stored in the pack case.

A vehicle according to an embodiment of the present disclosure may include one or more battery packs according to an embodiment of the present disclosure or one or more battery modules according to an embodiment of the present disclosure. The vehicle according to the present disclosure may be, for example, an electric vehicle, a hybrid vehicle or a plug-in hybrid vehicle. The vehicle includes a four-wheeled vehicle and a two-wheeled vehicle. The vehicle 3 drives by receiving power from the battery pack or the battery module 10 according to an embodiment of the present disclosure.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

### Reference Signs

10: battery module
100: cell stack
110: battery cell
111: storage portion
112: sealing portion
113: electrode lead
120: first blocking member
130: second blocking member
200: compression member
300: pressurizing member
400: module case
410: case body
420: end plate
500: bus bar frame
510: main frame
511: protrusion
512: lead slot
520: lower frame
521: placing portion
522: coupling portion
600: bus bar

What is claimed is:

1. A battery module comprising:
a cell stack including a plurality of battery cells;
a compression member disposed on at least one side of the cell stack and interposed in a gap between the battery cells, the compression member being configured to be shape-deformable by an external pressure; and
a pressurizing member configured to pressurize the compression member on the at least one side of the cell stack.

2. The battery module according to claim 1,
wherein the compression member is interposed at least partially between sealing portions of neighboring battery cells.

3. The battery module according to claim 2,
wherein the compression member is interposed at least partially between storage portions of neighboring battery cells.

4. The battery module according to claim 2,
wherein the pressurizing member is provided in plurality and is respectively provided between the sealing portions of the neighboring battery cells.

5. The battery module according to claim 1,
wherein the pressurizing member is configured to be partially in surface contact with the compression member.

6. The battery module according to claim 1,
wherein the pressurizing member is configured to extend in a height direction of the battery cell.

7. The battery module according to claim 1,
wherein the pressurizing member is provided on a side where electrode leads of the battery cell are located.

8. The battery module according to claim 1, further comprising:
a bus bar frame coupled to at least one side of the cell stack and configured to pressurize the pressurizing member toward the cell stack.

9. The battery module according to claim 8,
wherein the pressurizing member is mounted to the bus bar frame.

10. The battery module according to claim 9,
wherein the bus bar frame has a protrusion configured by at least partially protruding to contact the pressurizing member.

11. The battery module according to claim 9,
wherein the bus bar frame includes:
a main frame configured to cover one side of the cell stack, and
a lower frame bent from a lower portion of the main frame toward the cell stack to cover a lower portion of the compression member.

12. The battery module according to claim 11,
wherein the lower frame includes:
a placing portion configured so that the cell stack is placed thereon, and
a coupling portion configured so that the pressurizing member is coupled thereto.

13. The battery module according to claim 1,
wherein the cell stack further includes a first blocking member disposed at an outermost side of the cell stack and configured to protrude outward rather than the pressurizing member.

14. The battery module according to claim 13,
wherein the cell stack further includes a second blocking member disposed between the battery cells, and
wherein a length of the first blocking member is longer than a length of the second blocking member.

15. A battery pack comprising at least one battery module according to claim 1.

16. A vehicle comprising at least one battery module according to claim 1.
